(19) United States
(12) Patent Application Publication
(10) Pub. No.: US 2015/0272172 A1
(43) Pub. Date: Oct. 1, 2015

(54) MANUFACTURING METHOD OF BROWN SEAWEED EXTRACTS CONTAINING ALGINATE

(71) Applicant: Ye Eun KOO, Chungcheongnam-do (KR)

(72) Inventor: Ye Eun KOO, Chungcheongnam-do (KR)

(21) Appl. No.: 14/476,037

(22) Filed: Sep. 3, 2014

(30) Foreign Application Priority Data
Mar. 28, 2014 (KR) 10-2014-0036497

(51) Int. Cl. A23L 1/015; A23L 1/337

(52) U.S. Cl. CPC A23L 1/0155; A23L 1/337; A23V 2002/00

(57) ABSTRACT

A method of preparing a brown seaweed extract containing alginate is disclosed. The method includes washing brown seaweed containing alginate to remove impurities, mixing alginate contained in the brown seaweed with glycerin by precipitating and soaking at a temperature of 70 to 80° C. for 4 to 6 hours after precipitating the brown seaweed, where the impurities are removed, in 110-120 parts by weight of a mixture including water and glycerin based on 100 parts by weight of the brown seaweed soak, stirring and maturing the brown seaweed precipitated and soaked in the mixture at a temperature of 5° C.-40° C. for three to seven days, and eluting by compressing the matured brown seaweed with the mixture, and concentrating the brown seaweed extract by distilling water at a temperature of 75 to 105° C. for 4 to 6 hours after adding the eluted extract to a vacuum condenser.

### BACKGROUND OF THE INVENTION

1. Field of the Invention

The present invention relates to a method of preparing a brown seaweed extract containing alginate and, more particularly, to a method of preparing a brown seaweed extract containing alginate having a function of emulsification to prevent decomposition of the brown seaweed extract for long-term storage.

2. Description of the Related Art

Generally, brown seaweed refers to a kind of sea algae. The brown seaweed used principally for food lives in cold pools. However, sea mustard lives not only in the cold pools but also in warm pools. Brown seaweed contains chlorophyll based pigments such as chlorophyll-α and phycophene of chloroplasts. Cell membranes of brown seaweed are formed of alginate, which is a unique polysaccharide. However, some brown seaweed seasonally accumulates β-glucan based polysaccharides such as laminarin. In addition, since the brown seaweed contains sugar alcohol such as mannitol in large amounts, sugar alcohol is deposited on a surface of the brown seaweed on drying. The brown seaweed includes sea algae such as kelp, sea mustard, sargassum fusiforme and rhubarb.

Sea mustard has a large amount of dietary fiber, potassium, calcium, iodine, and the like and, as such, raises metabolism and is effective for post-natal recovery, prevention of constipation and obesity, and supplement of iron and calcium. Thus, sea mustard is a very popular food.

In addition, kelp contains a variety of pigments such as carotenes, xanthophylls, chlorophyll and the like, carbohydrates such as mannite, laminarin and the like formed by carbon dioxide assimilation, alginate and iodine constituting cell walls, vitamin B2, glutamic acid, amino acids and the like, in large amounts.

Although ingredients of the brown seaweed vary according to a kind of the brown seaweed , most brown seaweed contains, approximately, 16% water, 7% protein, 1.5% fat , 49% carbohydrates and 26.5% inorganic salts. Here, carbohydrate consists of 20% cellulose, and 80% polysaccharides including alginate, laminarin and the like. Brown seaweed contains, particularly, inorganic salts such as iodine, potassium, calcium and the like. Thus, when the kelp is consumed, inorganic salts are provided to the human body and, as such, a variety of deficiencies may be prevented. Particularly, brown seaweed contains approximately 10 to 30% alginate. Alginate contents vary according to a kind of brown seaweed. Polysaccharides present in cell walls of brown seaweed include D-mannuronic acid and L-guluronic acid monosaccharide. The D-mannuronic acid and L-guluronic acid monosaccharide envelope cell walls. Since alginate has characteristics such as gel formation, moisture retention, wound protection, dry control, reaction with metal ions, settlement, film formation and the like, it is utilized as a raw material in the fields of textiles, food and medicine. In addition, physical, chemical and enzymatic methods of extracting alginate have been developed.

To easily intake sea mustard or kelp, a method processing sea mustard or kelp into a solution state has been developed. However, the solution produced by the developed method easily is decomposed and, as such, is not suitable for long-term storage. Thus, for long-term storage, the solution produced by the developed method should be dried, or preservatives should be added to the solution.

Patents utilizing ingredients of sea mustard or kelp as described above are as follows: Korean Patent Application Pub. No. 10-1997-0073394 (METHOD FOR EXTRACTING TANGLE EXTRACT AND TANGLE EXTRACT THEREBY), Korean Patent No. 10-1067648 (THE PROCESSING METHOD OF LAMINARIA EXTRACT WITH CHOLROPHYLL), U.S. Pat. No. 07,309,686 (PROCESS FOR PRODUCING NATURAL SURFACTANTS AND COMPOSITIONS BASED ON NATURAL SURFACTANTS) and the like.

However, the inventions also require preservatives to prevent decomposition of sea mustard or kelp extracts. In addition, extracts of the kelp extracted according to the inventions has a salty or fishy taste and thereby, it is not easy consumers to intake the extracts continuously.

Furthermore, when raw materials of processed food and cosmetic products, except for natural plants, are processed into products, preservatives are utilized in the majority of the products. However, when preservatives are synthesized by chemicals, the synthesized preservatives include ingredients inducing a variety of cancers and affecting a bad influence on sexual organs. Thus, the synthesized preservatives are defined as materials harmful to the human body and, as such, use of the synthetic preservatives is restricted.

### PRIOR ART LITERATURE

### Patent Literature

(PATENT LITERATURE 001) Korean Patent Application Pub. No. 10-1997-0073394 (published on Dec. 10, 1997) (PATENT LITERATURE 002) Korean Patent No. 10-1067648 (registered on Sep. 20, 2011)

(PATENT LITERATURE 003) U.S. Pat. No. 07,309,686 (registered on Dec. 18, 2007)

### Non-Patent Literature

(NON-PATENT LITERATURE 001) Food Engineering Progress Vol, 3, No, 2, pp. 99-97 (1999), STUDY ON PROCESS EXTRACTING EFFICIENTLY ALGINATE FROM KELP.

(NON-PATENT LITERATURE 002) J Korean Soc Food Sci Nutr, 33 (4), 747-752 (2004), YIELD RATE AND VISCOSITY OF ALGINATE FROM SEA ALGAE DEPENDENT ON EXTRACTION CONDITIONS.

### SUMMARY OF THE INVENTION

Therefore, the present invention has been made in view of the above problems, and it is an object of the present invention to provide a brown seaweed extract containing alginate having an emulsification function to increase the viscosity of the brown seaweed extract and store the brown seaweed extract for term period without decomposition by eluted and mixed sticky ingredients containing alginate after precipitating brown seaweed containing alginate with mixture where water and glycerin are mixed.

It is another object of the present invention to provide a brown seaweed extract containing alginate, which may be used as an emulsification agent for oily and aqueous materials and as an emulsification agent for mixing powder with vegetable aqueous material solutions or oily materials.

In accordance with the present invention, the above and other objects can be accomplished by the provision of a method of preparing the brown seaweed extract containing alginate, the method including washing brown seaweed containing alginate to remove impurities, mixing alginate contained in brown seaweed with glycerin by soaking and distilling at a temperature of 70 to 80° C. for 4 to 6 hours after precipitating brown seaweed, from which the impurities have been removed, in 110-120 parts by weight of a mixture including water and glycerin based on 100 parts by weight of brown seaweed, stirring and maturing brown seaweed being precipitated while being soaked at a temperature of 5° C.-40° C. for three to seven days, eluting by compressing the matured brown seaweed with the mixture; and

concentrating the brown seaweed extract while distilling at a temperature of 75 to 105° C. for 4 to 6 hours after adding the extract extracted by eluting into a vacuum condenser.

The mixture may include 10-50 parts by weight of glycerin based on 100 parts by weight of water.

The mixture may further include 5-10 parts by weight of psyllium based on 100 parts by weight of the mixture.

The brown seaweed may include sea mustard or kelp.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flowchart illustrating a method of preparing a brown seaweed extract according to an embodiment of the present invention.

### DETAILED DESCRIPTION OF THE INVENTION

Hereinafter, a method of preparing a brown seaweed extract containing alginate according to the present invention will be described in detail with reference to the accompanying drawings.

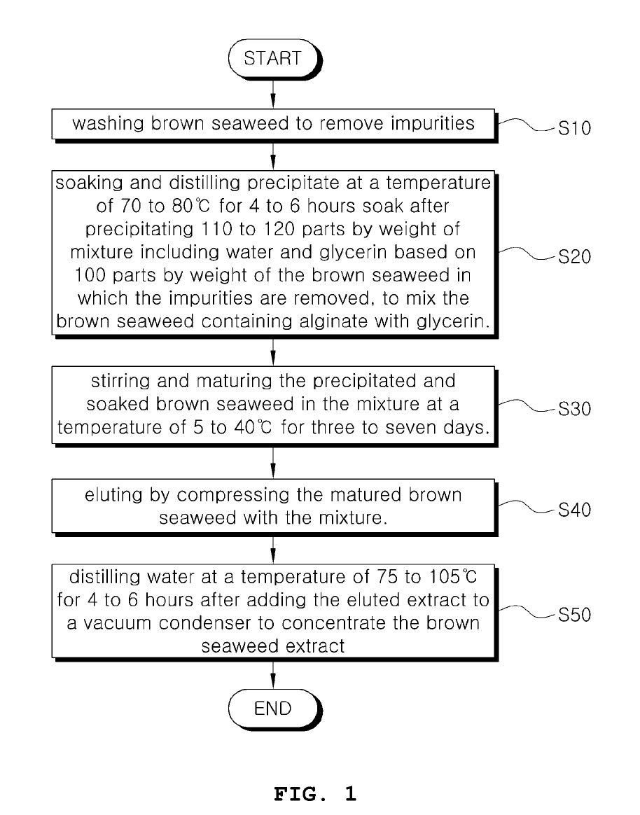

FIG. 1 is a flowchart illustrating a method of preparing the brown seaweed extract containing alginate according to an embodiment of the present invention.

As shown in FIG. 1, the present invention relates to a method of eluting sea mustard or kelp extract after adding a glycerin solution to brown seaweed, particularly sea mustard or kelp, containing alginate, to improve the viscosity of the extract and prevent decomposition of the extract for a long-term storage.

Generally, glycerin is a viscous, colorless and odorless material. Here, glycerin having a concentration of 10% or less may be utilized. If glycerin having a concentration higher than the above concentration is utilized, the glycerin, which is hygroscopic, absorbs moisture in air. Glycerin also functions as a preservative. In addition, the glycerin relieves stimulation of a dilution solution and, as such, intenerates an affected part.

Furthermore, treatment agents mixed with an adequate amount of glycerin supply moisture to hair or skin, and by the mixed glycerin, drying of the treatment agents may be prevented.

The method preparing the brown seaweed extract containing alginate consists of a washing step S10, mixing step S20, maturing step S30, elution step S40 and concentrating step S50.

The washing step S10 is a step washing brown seaweed, particularly sea mustard or kelp, to remove impurities. Here, the sea mustard or kelp utilized in the wasing step S10 includes undried sea mustard and kelp, and dried sea mustard and kelp.

The mixing step S20 is a step of mixing the sea mustard or kelp with glycerin by soaking and distilling at a temperature of 70 to 80° C. for 4 to 6 hours after precipitating 110-120 parts by weight of a solution, which is a mixture of water and glycerin, based on 100 parts by weight of the sea mustard or kelp in which impurities are removed.

Here, the mixture may include 10-50 parts by weight of glycerin based on 100 parts by weight of water.

When glycerin is mixed with water as described above, the viscosity of the sea mustard or kelp extract is increased, and is not reduced in spite of long-term storage at room temperature. Thus, decomposition of the sea mustard or kelp extract may be prevented and the sea mustard or kelp extract may be stored for a long period of time.

Furthermore, in the mixing step S20, a small quantity of sea mustard or kelp ingredients is eluted into solution and as such, the eluted ingredients are mixed with the solution on heating the sea mustard or kelp.

In the mixing step S20, to suppress proliferation and recurrence of cancer cells by activating immune function in the human body, chaga mushrooms may further be mixed with the solution. The chaga mushrooms include a large amount of beta-glucan, a polysaccharide, having immuno-potentiating activities.

Furthermore, in the mixing step S20, the mixture may further include 5-10 parts by weight of psyllium based on 100 parts by weight of the mixture. The psyllium has effects such as removing heat from the small intestine. The psyllium relieves dysentery and diarrhea induced by the heat and humidity, and diuresis.

In the maturing step S30, the sea mustard or kelp, which is precipitated and soaked in the mixture, is stirred at a temperature of 5° C.-40° C. for 3-7 days and then, is matured at room temperature. Due to friction induced by the stirring during the maturing step S30, kelp or sea mustard ingredients eluted from the glycerin solution may increase.

In the elution step S40, the matured sea mustard or kelp is compressed with the mixture to elute solution.

The concentrating step S50 is a step to distill water at a temperature of 75 to 105° C. for 4 to 6 hours after adding the eluted solution to a vacuum condenser to concentrate the brown seaweed extract.

In the concentrating step S50, when water is distilled, glycerin is not evaporated and remains in solution. Thus, the ingredients of the sea mustard or kelp are mixed with the glycerin solution and, as such, the sea mustard or kelp extract is obtained. The sea mustard or kelp extract obtained according to the above method includes less than 10% of moisture. In addition, light green colored or dark-brown extract may be obtained from the glycerin solution including the sea mustard or kelp ingredients.

Distilled water may further be mixed with the sea mustard or kelp extract obtained according to the above method.

Experiments to describe embodiments of the method of preparing the brown seaweed extract containing alginate are as follows.

First, 2 kg of undried raw kelp and 10.5 L of glycerin mixture having a concentration of 10% are input to two vacuum condensers. A first condenser is heated to a temperature of 70° C. for six hours, whereas a second condenser is heated to a temperature of 120° C. for four hours while distilling water to elute kelp ingredients.

As a result, 4 L of water was distilled from the first condenser, which was distilled at a temperature of 70° C. for six hours to elute the kelp ingredients. Whereas, 6 L of water was distilled from the second condenser at a temperature of 120° C. for four hours to elute the kelp ingredients.

Thereafter, the first condenser, in which 4 L of water had been distilled, was matured and stirred for six days. Whereas, the second condenser, in which 6 L of water had been distilled, was matured and stirred for three days. Here, the stirring rate of each condenser was 1.5 RPM.

Each of solutions concentrated in the first and second condensers was compressed and, as such, 7 L and 7.5 L of solutions were eluted from the first and second condensers, respectively. Thus, an amount of the solutions eluted from the first and second condensers was not different greatly and thereby, both of the solutions had high viscosity. After adding the solutions into each of the vacuum condensers, the solutions were eluted at a temperature of 75 to 105° C. for six hours. As a result, 1.7 kg and 1.8 kg of kelp compositions were extracted, and 7 L and 6.5 L of water were distilled, from the vacuum condensers, respectively. These extract include 0.5 L of glycerin added in the first step, and 1.2 kg and 1.3 kg of solutions including alginate, respectively. Results are summarized in the following Table 1.

TABLE 1

| | | | | First | | |
|---|---|---|---|---|---|---|
| | | Added | | distillated | Compressed | |
| | | volume | Mixture | amount | extract | Solution |
| Raw | 70° C. | 2 kg | 10.5 L | 4 L | 7 L | 1.7 kg |
| kelp | 120° C. | 2 kg | 10.5 L | 6 L | 6.5 L | 1.8 kg |

| | | | | | |
|---|---|---|---|---|---|
| Dried kelp | 1 kg | 10.5 L | 5 L | 3 L | 1.1 kg |
| Raw sea | 2 kg | 10.5 L | 6 L | 7 L | 1.8 kg |
| mustard | | | | | |
| Dried sea | 1 kg | 10.5 L | 4.5 L | 3 L | 0.9 kg |
| mustard | | | | | |

10 ml of the resulting kelp composition was added to containers to observe decomposition of the composition.

According to a general observation method conducted in laboratories for biological experiments, it was not easy exactly to observe proliferation of germs as cell cultureing in potato, agar and kelp powder solutions used as a medium. Thus, the kelp compositions were cultured at room temperature. Degree of decomposition over time was determined by smell and with the naked eye. Solutions prepared for this experiment are as follows: One solution was prepared by mixing water with kelp powder to prepare a viscous solution. The other solution was kelp and sea mustard extract obtained from the present invention.

Results are summarized in the following Table 2.

TABLE 2

| | After | | After | | After | | After | |
|---|---|---|---|---|---|---|---|---|
| Period | three days | | seven days | | ten days | | fifteen days | |
| Evaluation basis | Smell | State | Smell | State | Smell | State | Smell | State |
| Kelp | 0 | x | 1 | o | 3 | o | Unevaluatable | Unevaluatable |
| powder | | | | | | | | |
| solution | | | | | | | | |
| kelp | 0 | x | 0 | x | 0 | x | 0 | x |
| extract | | | | | | | | |
| sea | 0 | x | 0 | x | 0 | x | 0 | x |
| mustard | | | | | | | | |
| extract | | | | | | | | |

Decomposition smell were classified into 0 to 3. Mold generation due to decomposition was disclosed to o or x.

As shown in Table 2, in the solution prepared with kelp powder, decomposition occurred and mold was observed after seven days of culturing, whereas, no change was observed in the kelp and sea mustard extract according to the present invention.

Thereafter, the function of emulsification was tested. The kelp and sea mustard contain 10-30% of alginate ingredients. As alginate is a polysaccharide constituting cell membranes of brown seaweed, alginate is precipitated when brown seaweed washed with diluted sulfuric acid is extracted in diluted alkaline warm water such that the extract becomes acidic. The present invention does not aim to extract alginate from kelp and sea mustard. The present invention aims to obtain glycerin solution containing alginate ingredients effectively and usefully to use the ingredients mixed with the glycerin mixture after eluting into glycerin mixture due to heating or friction during stirring, of general ingredients. The solution obtained according to the above purpose had emulsification function.

Particularly, since alginate is insoluble and sodium salt is soluble in water, viscosity of the solution are increased greatly when alginate and sodium salt are dissolved. Thus, the solution is treated with a diluted acid or alkali and then, impurities, such as protein, fiber and the like are removed from the solution are removed. Thereafter, the solution is prepared in powder form with alcohol after dehydration and drying processes. The prepared powder is used for increasing the viscosity of textile glue, water based paint, emulsifying agents, and foods such as ice cream jam, mayonnaise and the like. However, the powder produced according to the above method is not suitable for long-term storage due to decomposition and thus preservatives should be added. Thus, alginate and other ingredients of the kelp and sea mustard are eluted into glycerin mixture solution and then, the solution containing the eluted extract according to the method of the present invention is compressed and distilled to obtain the extract containing glycerin, and kelp and sea mustard ingredients.

In “Method of extracting with enzyme” of U.S. Pat. No. 07,309,686 (PROCESS FOR PRODUCING NATURAL SURFACTIANTS AND COMPOSITIONS BASED ON NATURAL SUFRACTANTS), it is described that alginate extracted from the kelp and sea mustard contains ingredients having emulsifying effects. However, the present invention is different from the above invention, U.S. Pat. No. 07,309,686, in that the extract of the kelp and sea mustard eluted into the glycerin is distilled to mix with the glycerin. The emulsifying effects of the kelp solution obtained according to the present invention are shown in following Table 3.

TABLE 3

| | | | Retention of |
|---|---|---|---|
| | | | emulsification |
| Mixtures | Ratios | Properties | state |
| Water + | 1:1:1 | Light green | Not separated |
| cooking oil + | | colored watery | |
| kelp extract | | cream | |
| | 1:2:3 | White hard | Good |
| | | cream | |
| | 1:2:1 | Light green | Separated |
| | | colored watery | |
| | | lotion | |
| Powder + | 1:1:1 | Light green | Not separated |
| cooking oil + | | colored watery | |
| kelp extract | | lotion | |
| | 1:2:3 | Light green | Not separated |
| | | colored solid | |
| | | drug | |
| | 2:2:1 | Light green | Not separated |
| | | colored watery | |
| | | cream | |
| Cooking oil + | 1:1 | Light brown | Not separated |
| kelp extract | | colored drug | |
| | | cream | |
| | 1:2 | Light brown | Not separated |
| | | colored or | |
| | | brown colored | |
| | | cream | |

As a result, a cream applicable on skin as a cosmetic product and a drug were prepared. Here, the cream was prepared with only kelp extract, without natural surfactants, or surfactants synthesized with sulfuric acid or nucleic acid, to emulsify oil.

Most cosmetic products contain purified water, glycerin, a small amount of vegetable oil and the like. It was impossible to prepare cream only with glycerin and vegetable oil, without purified water. The cream prepared by such a method was so sticky after being applied to the skin that the cream could not be used on the skin. However, without purified water, a cream was prepared by mixing a small quantity of oil and the extract of the present invention in a ratio of 1:3 to apply to the skin. As a result, the cream was not sticky at all when applied to the skin. In addition, after applying the cream, moisture of skin was maintained for longer periods. Therefore, the cream prepared according to the present invention is very useful for people requiring sufficient moisture supply such as patients suffering from an atopic disease, psoriasis and the like.

By the method of preparing the cream, medicine such as ointment and the like may also be prepared without materials harmful to human health.

As is apparent from the above description, the present invention provides a method of preparing the brown seaweed extract containing alginate, having increased viscosity by eluting after adding glycerin to the brown seaweed extract containing alginate to have effects such as improvement of moisturizing effect of cosmetics, moisture supply to patients suffering from psoriasis or an atopic disease, prevention of decomposition of the brown seaweed extract for long-term storage

In addition, the brown seaweed extract containing alginate may be used as an emulsification agent for oily and aqueous materials, and for mixing powder with vegetable aqueous material solutions or oily materials. the brown seaweed extract containing alginate may also be used as a raw material of cosmetics instead of synthesized surfactants due to emulsification function mixing oily and aqueous materials. Furthermore, the brown seaweed extract containing alginate may prevent environmental pollution through water quality improvement by utilizing the brown seaweed extract containing alginate instead of synthetic surfactants.

In addition, the brown seaweed extract containing alginate may be used as raw material to prepare gelatin, instead of a mixing agent of soft capsules such as palm oil, lecithin and titanium dioxide. Furthermore, the brown seaweed extract containing alginate may be used as a raw material for preparing gelatin of soft and hart capsules in health foods or drugs.

In addition, the brown seaweed extract containing alginate may have effects such as removing heat from the small intestine, and helping dysentery and diarrhea induced by the heat and humidity to be stopped, and a diuretic effect, by adding psyllium.

The scope of the present invention is not limited to the embodiments described above and is defined only by the contents of the following claims. Those skilled in the art will appreciate that various modifications, additions and substitutions are possible, without departing from the scope and spirit of the invention as disclosed in the accompanying claims.

What is claimed is:

1. A method preparing a brown seaweed extract containing alginate, the method comprising:
washing a brown seaweed containing the alginate to remove impurities;
mixing the alginate contained in the brown seaweed with glycerin by soaking and distilling at a temperature of 70 to 80° C. for 4 to 6 hours after precipitating the brown seaweed, from which the impurities have been removed, in 110-120 parts by weight of a mixture comprising water and glycerin based on 100 parts by weight of the brown seaweed;
stirring and maturing the brown seaweed precipitated and soaked, at a temperature of 5° C-40° C. for three to seven days;
eluting by compressing the matured brown seaweed with the mixture; and
concentrating the brown seaweed extract while distilling at a temperature of 75 to 105° C. for 4 to 6 hours after adding extract extracted by the eluting in a vacuum condenser.

2. The method according to claim 1, wherein the mixture comprises 10-50 parts by weight of glycerin based on 100 parts by weight of water.

3. The method according to claim 1, wherein the mixture further comprises 5-10 parts by weight of psyllium based on 100 parts by weight of the mixture in the mixing step.

4. The method according to claim 1, wherein the brown seaweed comprises sea mustard or kelp.
